(19) United States
(12) Patent Application Publication
(10) Pub. No.: US 2025/0227435 A1
(43) Pub. Date: Jul. 10, 2025

(54) METHOD AND NETWORK NODE

(71) Applicant: NEC Corporation, Minato-ku, Tokyo (JP)

(72) Inventor: Tingyu XIN, Tokyo (JP)

(73) Assignee: NEC Corporation, Minato-ku, Tokyo (JP)

(21) Appl. No.: 18/853,811

(22) PCT Filed: Apr. 4, 2023
(86) PCT No.: PCT/JP2023/014014

§ 371 Date: Oct. 3, 2024

(30) Foreign Application Priority Data
Apr. 8, 2022 (GB) 2205224.5

(51) Int. Cl. H04W 4/029; H04B 7/185; H04B 17/27

(52) U.S. Cl. CPC H04W 4/029; H04B 7/1851; H04B 17/27

(57) ABSTRACT

The present disclosure relates to a method performed by a first network node in a network comprising a non-terrestrial network portion, the method comprising: receiving measurement information corresponding to a measurement of a user equipment, UE, via a satellite (5) of the non-terrestrial network portion; receiving assistance information for determining a position of the satellite; determining, using the assistance information, a position of the satellite; and determining a location of the UE based on the position of the satellite and the measurement information.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to the so-called ‘5G’ (or ‘Next Generation’) systems employing a non-terrestrial portion comprising airborne or spaceborne network nodes.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN)/radio access technology (RAT) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

3GPP is also working on specifying an integrated satellite and terrestrial network infrastructure in the context of 4G and 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

3GPP Technical Report (TR) 38.811 V15.4.0 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). 3GPP TR 38.821 V16.1.0 provides further details about NTN.

Non-Terrestrial Networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refers to the radio link between the user equipment and the space/airborne platform (which may be in addition to a radio link with a terrestrial based RAN).
A space or an airborne platform (e.g. a satellite).
Gateways (‘NTN Gateways’) that connect the satellite or aerial access network to the core network. It will be appreciated that gateways will mostly likely be co-located with a base station. Alternatively, the gateway and base station may be provided separately. In one alternative, some or all of the functions of the base station may instead be provided at the satellite (or another non-terrestrial node).
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g. NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals. Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’).

In a non-terrestrial network, it is important that the location of a UE using the network is known, for example for time and frequency compensation, among other uses. A UE may be configured to use a Global Navigation Satellite System (GNSS) in order to determine or estimate the position of the UE. However, not all UEs are provided with GNSS capability. Moreover, a GNSS-based determination of the position of the UE may not be trustable by the network. It is advantageous, therefore, to provide a network-based positioning method that is able to determine (or estimate) the position of a UE, even when the UE does not support GNSS, in a manner that is trustable by the network.

Having a reliable and trustable location of the UE is also important for regulated services such as lawful intercept, public warning services and emergency communications. The provision of a network-based positioning method enables these services to be provided via satellites in the NTN.

Various methods can be used to estimate a position of a UE in a terrestrial network. Such methods may involve transmitting or receiving a signal at multiple base stations in order to estimate the location of the UE. However, when similar methods are applied using a non-terrestrial portion (e.g. satellites) of a NTN, there is an additional technical challenge that the satellites are moving (e.g. in a non-geostationary orbit), introducing some uncertainty in the position of the satellites when signals to and from the UE are transmitted/received. Moreover, compared to fully terrestrial networks, there is a significant propagation delay for signals being transmitted between terrestrial elements of the NTN (e.g. a UE or a base station) and the non-terrestrial part of the network (e.g. a satellite). Methods for determining a position of a UE that account for such propagation delays and the movement of the non-terrestrial nodes are needed.

### SUMMARY OF INVENTION

### Technical Problem

The present disclosure seeks to provide methods and associated apparatus that address or at least alleviate (at least some of) the above-described issues.

### Solution to Problem

In a first aspect the disclosure provides a method performed by a first network node in a network comprising a non-terrestrial network portion, the method comprising: receiving measurement information corresponding to a measurement performed at a satellite of the non-terrestrial network portion; obtaining time information that indicates a time at which the measurement was performed at the satellite; obtaining path information for determining a position of the satellite based on the time information; determining, using the time information and the path information, a position of the satellite when the measurement was performed at the satellite; and determining a location of a user equipment, UE, based on the position of the satellite and the measurement information.

The time information may comprise at least one of a time associated with the satellite, and a time associated with a second network node that communicates with the satellite. The method may include receiving at least one of the time information and the measurement information from the second network node.

The time information may include the time associated with the second network node; and the time information may include a time offset between the time associated with the second network node and a time at which the measurement was performed at the satellite.

The time offset may include at least one of a propagation delay of signals between the satellite and the second network node, and a processing time at the second network node.

The method may comprise: calculating, using the time associated with the second network node and the time offset, the time at which the measurement was performed at the satellite; and determining the position of the satellite using the determined time at which the measurement was performed at the satellite and the path information.

The path information may include a table or an equation that indicates a position of the satellite as a function of time. The path information may include an ephemeris of the satellite.

The first network node may be a Location Management Function, LMF, and the second network node may be a base station or a transmission and reception point, TRP.

The measurement performed at the satellite may be based on a reference signal transmitted by the UE.

The method may comprise receiving the path information, via a base station, from a function responsible for access and mobility management, or from an operation and maintenance, OAM, node.

The method may comprise receiving the path information from the base station in a Transmission/Reception Point, TRP, Information Exchange Procedure.

In a second aspect the disclosure provides a method performed by a first network node in a network comprising a non-terrestrial network portion, the method comprising: receiving, from another network node, location information identifying a position of a satellite at which a measurement based on a reference signal from a user equipment, UE, has been performed; and receiving measurement information corresponding to the measurement performed at the satellite; wherein the location information indicates the position of the satellite when the measurement was performed; and wherein the method further comprises determining a position of the UE based on the position of the satellite and based on the measurement information.

The method may comprise receiving the location information from a second network node that communicates with the satellite.

In a third aspect the disclosure provides a method performed by a second network node in a network comprising a non-terrestrial network portion, the method comprising: obtaining, for a measurement based on a reference signal from a user equipment, UE, at a satellite, time information identifying a time corresponding to when the measurement was performed at the satellite; and transmitting the time information to a first network node; wherein the time information comprises at least one of a time associated with the satellite, and a time associated with the second network node.

The time identified by the time information may be associated with the second network node; and the method may further comprise transmitting, to the first network node, a time offset between the time associated with the second network node and a time at which the measurement was performed at the satellite.

The time offset may comprise at least one of a propagation delay of signals between the satellite and the second network node, and a processing time at the second network node.

The first network node may be a Location Management Function, LMF, and the second network node may be a base station or a transmission and reception point, TRP.

The method may further comprise transmitting, to the UE via the satellite, a reference signal configuration for transmitting the reference signal.

The method may further comprise transmitting, to the UE via the satellite, an instruction to activate transmission of the reference signal.

In a fourth aspect the disclosure provides a method performed by a first network node in a network comprising a non-terrestrial network portion, the method comprising: obtaining path information for determining a position of one or more satellites of the non-terrestrial network portion; determining, using the path information, respective positions of one or more satellites of the non-terrestrial network portion; and selecting, using the respective positions, one or more satellites to perform a measurement of a signal transmitted by a user equipment, UE, for determining a position of the UE.

The path information may include a table or an equation that indicates a position of each of the one or more satellites as a function of time.

The method may comprise receiving the path information from: a second network node that communicates with one or more satellites of the non-terrestrial network portion; a function responsible for access and mobility management; or an operation and maintenance, OAM, node.

In a fifth aspect the disclosure provides a method performed by a second network node in a network comprising a non-terrestrial network portion, the method comprising: receiving measurement information corresponding to a measurement performed at a satellite of the non-terrestrial network portion; obtaining time information that indicates a time at which the measurement was performed at the satellite; obtaining path information for determining a position of the satellite based on the obtained time information; determining, using the time information and the path information, a position of the satellite when the measurement was performed at the satellite; and transmitting the measurement information and location information that identifies the position of the satellite to a first network node for determining a location of a user equipment, UE.

The method may further comprise transmitting the time information to the first network node for determining a location of the UE.

In a sixth aspect the disclosure provides a first network node in a network comprising a non-terrestrial network portion, the first network node comprising: means for receiving measurement information corresponding to a measurement performed at a satellite of the non-terrestrial network portion; means for obtaining time information that indicates a time at which the measurement was performed at the satellite; means for obtaining path information for determining a position of the satellite based on the time information; means for determining, using the time information and the path information, a position of the satellite when the measurement was performed at the satellite; and means for determining a location of a user equipment, UE, based on the position of the satellite and the measurement information.

In a seventh aspect the disclosure provides a first network node in a network comprising a non-terrestrial network portion, the first network node comprising: means for receiving, from another network node, location information identifying a position of a satellite at which a measurement based on a reference signal from a user equipment, UE, has been performed; and means for receiving measurement information corresponding to the measurement performed at the satellite; wherein the location information indicates the position of the satellite when the measurement was performed; and wherein the method further comprises determining a position of the UE based on the position of the satellite and based on the measurement information.

In an eighth aspect the disclosure provides a first network node in a network comprising a non-terrestrial network portion, the first network node comprising: means for obtaining path information for determining a position of one or more satellites of the non-terrestrial network portion; means for determining, using the path information, respective positions of one or more satellites of the non-terrestrial network portion; and means for selecting, using the respective positions, one or more satellites to perform a measurement of a signal transmitted by a user equipment, UE, for determining a position of the UE.

In a ninth aspect the disclosure provides a second network node in a network comprising a non-terrestrial network portion, the second network node comprising: means for obtaining, for a measurement based on a reference signal from a user equipment, UE, at a satellite, time information identifying a time corresponding to when the measurement was performed at the satellite; and means for transmitting the time information to a first network node; wherein the time information comprises at least one of a time associated with the satellite, and a time associated with the second network node.

In a tenth aspect the disclosure provides a second network node in a network comprising a non-terrestrial network portion, the second network node comprising: means for receiving measurement information corresponding to a measurement performed at a satellite of the non-terrestrial network portion; means for obtaining time information that indicates a time at which the measurement was performed at the satellite; means for obtaining path information for determining a position of the satellite based on the obtained time information; means for determining, using the time information and the path information, a position of the satellite when the measurement was performed at the satellite; and means for transmitting the measurement information and location information that identifies the position of the satellite to a first network node for determining a location of a user equipment, UE.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the disclosure will now be described, by way of example, with reference to the accompanying drawings in which:

FIG. 1 illustrates schematically a mobile (cellular or wireless) telecommunication system to which example embodiments of the disclosure may be applied;

FIG. 2 shows a further schematic illustration of a system to which example embodiments of the disclosure may be applied;

FIG. 3 shows a modification of the system of FIG. 2, in which functions of the base station/TRP are provided at the serving satellite;

FIG. 4 shows a modified version of the schematic illustration of FIG. 2, in which neighbour satellites are also shown;

FIG. 5 is a schematic block diagram of a mobile device;

FIG. 6 is a schematic block diagram of an NTN node (e.g. satellite/UAS platform);

FIG. 7 is a schematic block diagram of an access network node (e.g. base station);

FIG. 8 is a schematic block diagram of a Location Management Function;

FIG. 9 illustrates schematically an estimation of a position of a UE using a plurality of base stations;

FIG. 10 shows an LMF-initiated Location Information Transfer Procedure;

FIG. 11 shows part of a Multi-RTT method for determining a distance between a UE and a base station/TRP;

FIG. 12 shows a Multi-RTT positioning procedure;

FIG. 13 shows a schematic illustration of uplink angle-of-arrival positioning;

FIG. 14 shows an UL-AoA/UL-TDOA positioning procedure;

FIG. 15 shows a schematic illustration of downlink angle-of-departure positioning;

FIG. 16A shows messages exchanged in a downlink angle-of-departure positioning method;

FIG. 16B shows messages exchanged in a downlink angle-of-departure positioning method;

FIG. 16C shows messages exchanged in a downlink angle-of-departure positioning method;

FIG. 17 shows a first part of a UE position estimation method;

FIG. 18 shows a second part of the UE position estimation method; and

FIG. 19 illustrates schematically some exemplary architecture options for the provision of NTN features.

### DESCRIPTION OF EMBODIMENTS

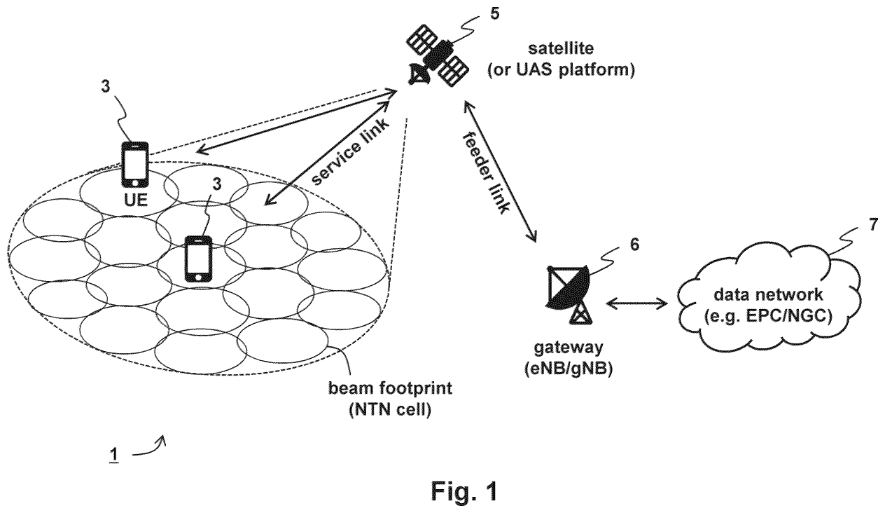

FIG. 1 illustrates schematically a mobile (cellular or wireless) telecommunication system 1 to which example embodiments of the disclosure may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an Evolved Universal Terrestrial Radio Access (E-UTRA) and/or 5G RAT. As those skilled in the art will appreciate, whilst two mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA (or ‘4G’) and/or New Radio (or ‘5G’) communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The data network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

When the UE 3 initially establishes an RRC connection with a base station 6 via a cell it registers with an appropriate AMF 9 (or MME). The UE 3 is in the so-called RRC connected state and an associated UE context is maintained by the network. When the UE 3 is served via the NTN node 5, it receives and transmits data via one of the beams (NTN cells) of the NTN node 5. When the UE 3 is in the so-called RRC idle or in the RRC inactive state, it still needs to select an appropriate cell for camping so that the network is aware of the approximate location of the UE 3 (although not necessarily on a cell level).

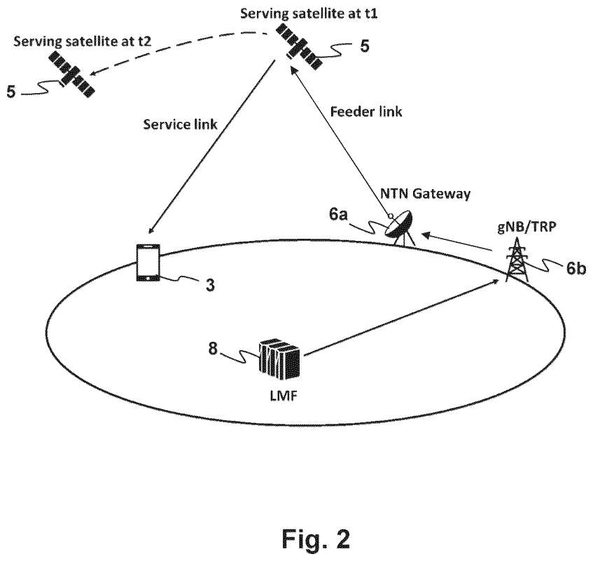

FIG. 2 shows a further schematic illustration of the system to which example embodiments of the disclosure may be applied. As shown in the figure, in this example the NTN gateway 6a and the gNB/TRP 6b are provided as terrestrial nodes. The service link between the UE 3 and the satellite 5, and the feeder link between the NTN gateway and the satellite 5 are shown. The NTN gateway is a transport network layer (TNL) node and provides sufficient RF power and RF sensitivity for communicating with the satellite 5.

The network includes a Location Management Function 8. The LMF 8 is a network entity in the 5G Core Network that supports location determination for the UE 3. As will be described below, the LMF 8 may, for example, obtain downlink location measurements or a location estimate from the UE 3, may obtain uplink location measurements from the NG RAN, or may obtain other suitable information from other entities in the network for estimating a position of the UE. For example, the serving satellite 5 may perform a measurement of a reference signal transmitted by the UE 3 for the purpose of determining an estimate of the location of the UE 3. The measurement information obtained at the service satellite 5 may be sent to the LMF 8 via the gateway 6a and the gNB/TRP 6b, and the LMF 8 may determine an estimate of the position of the UE 3 using the received measurement information.

Whilst the NTN gateway 6a and the gNB/TRP 6b are shown as separate nodes in FIG. 2, they may alternatively be co-located or provided as a single node. As described in detail below, in some examples a propagation delay between the satellite 5 and the gNB/TRP 6b is considered. When the NTN gateway 6a and the gNB/TRP 6b are co-located, the propagation delay of signals transmitted between the gateway 6a and the gNB/TRP 6b is reduced or eliminated, and so the signal propagation delay between the gNB/TRP 6b and the satellite 5 corresponds to the signal propagation delay of the feeder link. However, if the gateway 6a and the gNB/TRP 6b are not co-located, then the propagation delay of signals transmitted between the NTN gateway 6a and the gNB/TRP 6b may also be included in the total propagation delay between the gNB/TRP 6b and the satellite 5.

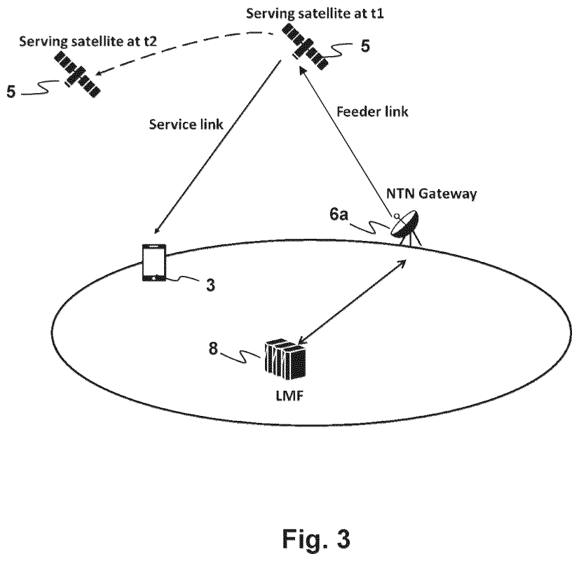

Whilst the system illustrated in FIG. 2 includes a terrestrial gNB/TRP 6b, some or all of the functions of the gNB 6b may be provided at the serving satellite. For example, FIG. 3 shows a modification of the system of FIG. 2 in which all of the functions of the gNB 6b are provided at the satellite 5, and the gateway 6a is arranged directly between the satellite 5 and the LMF 8.

The satellite 5 may be configured to implement a transparent or a regenerative payload. For a transparent payload, the satellite 5 performs radio frequency filtering, frequency conversion and amplification, and signals received at the satellite 5 are simply repeated for transmission to the terrestrial gateway 6a. In other words, the waveform signal repeated by the satellite 5 is substantially unchanged. An exemplary control plane protocol stack for a transparent payload (for a transparent satellite) is described, for example, in TS 38.821.

For a regenerative payload, the satellite 5 may be configured to perform radio frequency filtering, frequency conversion and amplification, demodulation/decoding, switching and/or routing, and coding/modulation. In other words, some or all of the functions of the gNB 6b are provided at the satellite 5. If only some of the functions of the gNB 6b are provided at the satellite (e.g. in the system shown in FIG. 2), then the terrestrial gNB 6b may comprise the gNB-CU (central unit) that includes higher layer functions (e.g. PDCP, RRC), and the functions of the gNB 6b at the satellite 5 may comprise, for example, a gNB-DU (distributed unit) that includes lower layer functions (e.g. PHY, MAC, RLC). In other words, the functions of the gNB 6b are split between a non-terrestrial node (the satellite 5) and a terrestrial node. If all of the functions of the gNB 6b are provided at the satellite 5, then the terrestrial gNB 6b may be omitted entirely, as shown in FIG. 3. An exemplary control plane protocol stack for a regenerative payload is described, for example, in TS 38.821.

### User Equipment (UE)

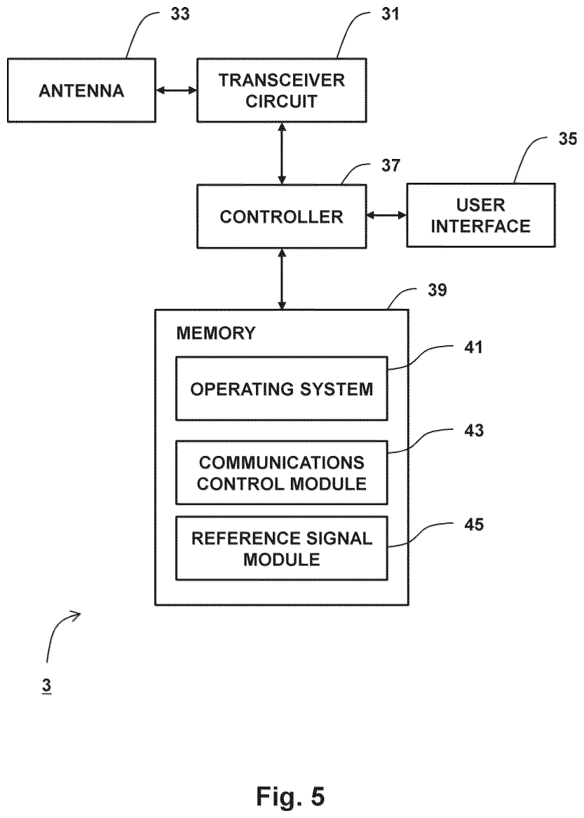

FIG. 5 is a block diagram illustrating the main components of the mobile device (UE) 3 shown in FIGS. 1 to 4. As shown, the UE 3 includes a transceiver circuit 31 which is operable to transmit signals to and to receive signals from the connected node(s) via one or more antenna 33. Although not necessarily shown in FIG. 5, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a reference signal module 45 (which is optional in some UEs).

The communications control module 43 is responsible for handling (generating/sending/receiving) signalling messages and uplink/downlink data packets between the UE 3 and other nodes, including NTN nodes 5, (R)AN nodes 6, and core network nodes. The signalling may comprise control signalling (such as RRC signalling) related to configuring and assisting cell reselection by the UE 3.

The reference signal module 45 is responsible for controlling the transmission of a reference signal. For example, the UE 3 may receive a reference signal configuration from the network (e.g. from the gNB 6b, via the NTN gateway 6a and the satellite 5), and may control the transmission of the reference signal. The reference signal module 45 may also be responsible for controlling a measurement of a reference signal transmitted by another entity in the network (e.g. by the satellite). The reference signal measurements can be used in the network (e.g. at the LMF 8) for estimating a position of the UE 3.

### NTN Node (Satellite/UAS Platform)

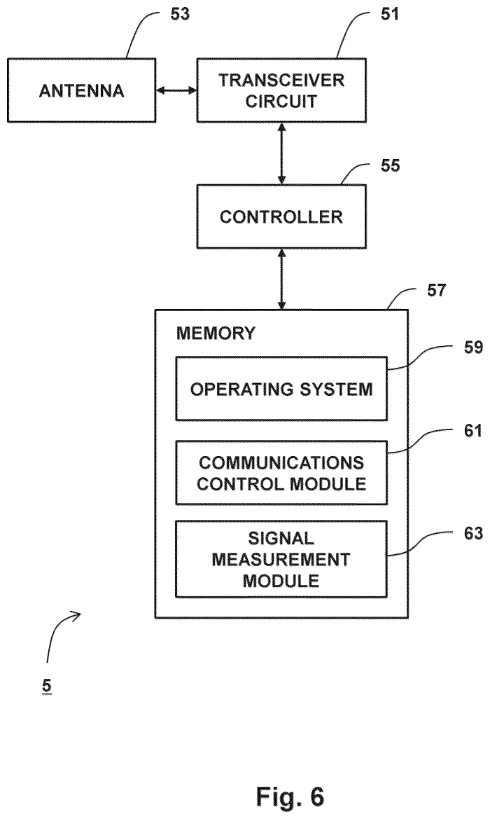

FIG. 6 is a block diagram illustrating the main components of the NTN node 5 (a satellite or a UAS platform) shown in FIGS. 1 to 4. As shown, the NTN node 5 includes a transceiver circuit 51 which is operable to transmit signals to and to receive signals from connected UE(s) 3 via one or more antenna 53 and to transmit signals to and to receive signals from other network nodes such as gateways and base stations (either directly or indirectly). A controller 55 controls the operation of the NTN node 5 in accordance with software stored in a memory 57. The software may be pre-installed in the memory 57 and/or may be downloaded via the telecommunication network 1 or from a removable data storage device (RMD), for example. The software includes, among other things, an operating system 59, a communications control module 61, and a signal measurement module 63.

The communications control module 63 is responsible for handling (generating/sending/receiving/relaying) signalling between the NTN node 5 and other nodes, such as the UE 3, base stations 6, gateways, and core network nodes (via the base stations/gateways). The signalling may comprise control signalling (such as RRC signalling) related to configuring and assisting cell reselection by the UE 3.

The signal measurement module 63 is responsible for performing a measurement corresponding to a UE 3, for estimating the position of the UE 3. The measurement may be a measurement according to any of the examples described below. For example, the signal measurement module 63 may control a measurement of a reference signal transmitted by the UE 3. The signal measurement module 63 may also generate a time corresponding to when the measurement was performed, and transmit the generated time to the network via the antenna 53.

### Base Station/Gateway (Access Network Node)

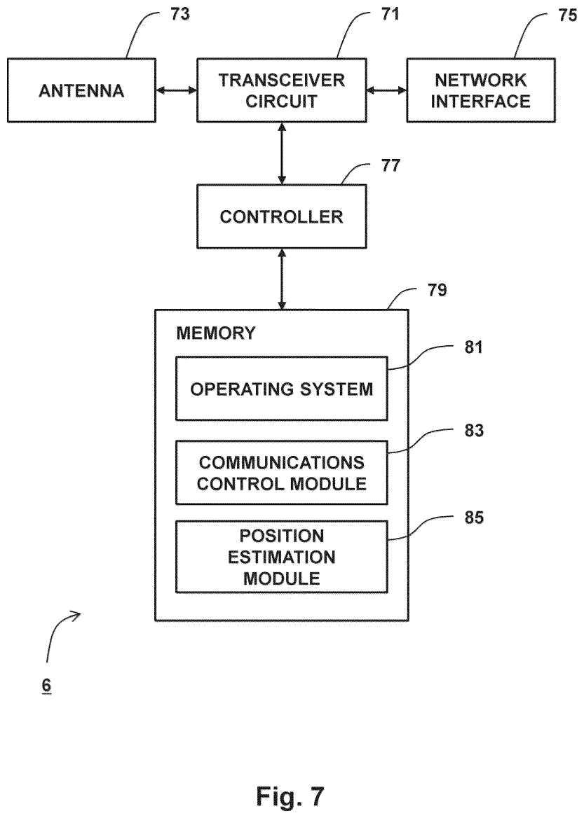

FIG. 7 is a block diagram illustrating the main components of the gateway/base station 6 shown in FIGS. 1 to 4 (a base station (gNB) or a similar access network node, the base station need not necessarily be a gNB 6). As shown, the gateway/base station 6 includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the NTN node 5, as appropriate. The network interface 75 typically includes an appropriate base station-base station interface (such as X2/Xn) and an appropriate base station-core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and a position estimation module 85.

The communications control module 83 is responsible for handling (generating/sending/receiving) signalling between the base station 6 and other nodes, such as the UE 3, NTN nodes 5, and core network nodes. The signalling may comprise control signalling (such as RRC signalling) related to configuring and assisting cell reselection by the UE 3.

The position estimation module 85 is responsible for handling measurements received from a non-terrestrial node (e.g. to transmit the received measurements to an LMF). The position estimation module 85 may also be responsible for determining a position of a satellite (or other non-terrestrial node) in the network. More generally, the position estimation module 85 may be configured to perform any of the positioning procedures for determining a position of a UE 3 or a non-terrestrial node (e.g. satellite) described below, including the generation of measurement times or time offsets.

### Location Management Function

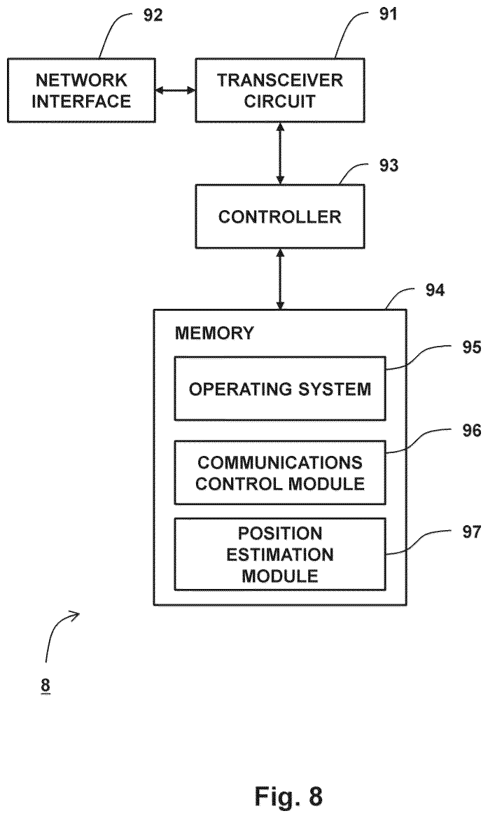

FIG. 8 is a block diagram illustrating the main components of the LMF 8 shown in FIGS. 1 to 4. As shown, the LMF 8 includes a transceiver circuit 71 which is operable to receive signals from other network nodes (either directly or indirectly) via a network interface 75. Signals may be transmitted to and received from the NTN node 5, the gNB/TRP 6, or the UE(s) 3 via the NTN node 5, as appropriate. The network interface 92 typically includes an appropriate core network-base station interface (such as S1/NG-C/NG-U). A controller 93 controls the operation of the LMF 8 in accordance with software stored in a memory 94. The software may be pre-installed in the memory 94 and/or may be downloaded via the telecommunication network 1 or from a removable data storage device (RMD), for example. The software includes, among other things, an operating system 95, a communications control module 96, and a position estimation module 97.

The communications control module 96 is responsible for handling (generating/sending/receiving) signalling between the LMF 8 and other nodes, such as the UE 3, NTN nodes 5, gNB/TRP 6, and other core network nodes.

The position estimation module 85 is responsible for handling measurements received from a non-terrestrial node (e.g. via the gNB/TRP 6), in order to determine an estimate of a position of a UE 3. The position estimation module 85 may also be responsible for determining a position of a satellite (or other non-terrestrial node) in the network. More generally, the position estimation module 97 may be configured to perform any of the positioning procedures for determining a position of a UE 3 or a non-terrestrial node (e.g. satellite) described below.

### Location Estimation Procedures

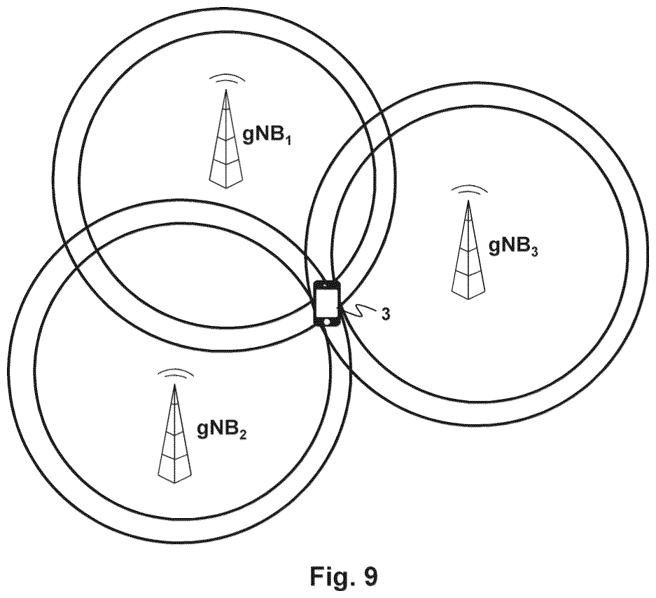

FIG. 9 shows an example of how a position of a UE 3 can be estimated using a plurality of nodes (in this example, using a plurality of gNBs, gNB₁ to gNB₃). Each gNB is associated with a corresponding ring that indicates an estimate of the distance of the UE 3 from the gNB. As illustrated in the figure, when an estimate of the distance of the UE 3 from each node has been determined, an estimate of the location of the UE 3 can also be determined (the point at which the distance estimates from each of the gNBs intersect). Whilst, for simplicity, the example shown in FIG. 9 illustrated using static terrestrial gNBs, it will be appreciated that method may also be implemented using a set of non-terrestrial nodes (e.g. satellites 5). However, whilst a terrestrial gNB is static, a non-geostationary satellite is moving relative to the surface of the Earth as it travels along its orbit (and is therefore moving relative to the UE 3), and so the location of the satellite 5 at the time of the measurements must also be established.

Whilst in the example shown in FIG. 9 a plurality of nodes are used to transmit/receive signals to estimate the position of the UE 3, this need not necessarily be the case. For example, a single satellite 5 of a NTN can be used to determine an estimate of the position of the UE 3, e.g. when the satellite 5 comprises a directional antenna and an uplink angle-of-arrival method (described below) is used.

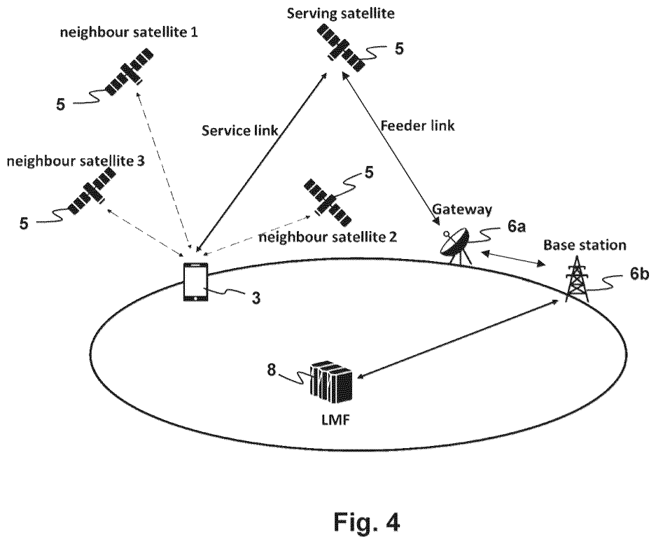

A description of exemplary location estimation procedures useful for understanding how a position of a UE 3 can be estimated by the transmission/reception of signals between the UE and a network node is set out below. For ease of understanding, the location estimation procedures are described with reference to terrestrial base stations. However, the procedures are useful for understanding how the location of a UE can be estimated using non-terrestrial nodes. For example, FIG. 4 shows a modified version of the schematic illustration of FIG. 2, in which neighbour satellites 5 are also shown, and the plurality of satellites 5 of FIG. 4 may be used to transmit/receive signals to/from the UE, to estimate the position of the UE 3. Methods for estimating a position of a UE are also described in TS 38.305.

The LMF 8 determines a positioning method to be used, interacts with the UE and gNBs (e.g. the serving gNB or neighbouring gNBs), and computes the location of the UE.

In some of the position estimation methods, a positioning reference signal is used (e.g. a downlink positioning reference signal). For example, the UE 3 may transmit a sounding reference signal (SRS).

### NR E-CID

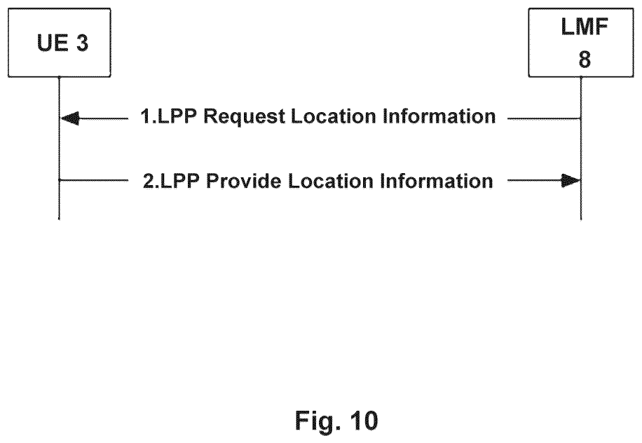

FIG. 10 shows an LMF-initiated Location Information Transfer Procedure that is part of an NR E-CID (enhanced cell ID) for estimating a location of a UE. The LMF-initiated Location Information Transfer Procedure is described in detail in TS 38.305.

E-CID is a network-based positioning method in which the UE 3 reports the measurements available for radio resource management (RRM), rather than being required to take additional measurement actions. In this method, the UE is generally not expected to make additional measurements for the sole purpose of positioning. The method does not require assistance data to be transferred from the LMF 8 to the UE 3 or gNB 6b, but has a relatively low positional accuracy.

The NR E-CID method may be used, for example, to obtain an initial estimate of the location of the UE 3 for use by the LMF 8 to select TRPs for subsequent measurements, to obtain a more accurate estimate of the position of the UE 3.

Downlink NR E-CID positioning procedures are LMF/UE initiated, and may be considered to be UE-assisted, LMF-based NR E-CID. These procedures comprise measurements that are provided by the UE 3.

In uplink NR E-CID positioning procedures, the LMF 8 requests position measurements from the gNB 6b. These procedures may be considered to be NG-RAN node assisted NR E-CID and comprise measurements that are provided by the serving gNB 6b.

UE measurements in NR E-CID are described in TS 38.215, and may comprise one or more of: SS Reference signal received power (SS-RSRP); SS Reference Signal Received Quality (SS-RSRQ); CSI Reference signal received power (CSI-RSRP); or CSI Reference Signal Received Quality (CSI-RSRQ).

The UE 3 may transmit the measurements, a NR Cell Global Identifier or Physical Cell ID to the LMF 8.

The gNB 6b may transmit, for example, an uplink (UL) Angle of Arrival (azimuth and elevation), NR/E-UTRA measurement results, Physical Cell ID (PCI), and/or Cell Global Identity (CGI) to the LMF 8.

### Multi-Round-Trip-Time (Multi-RTT)

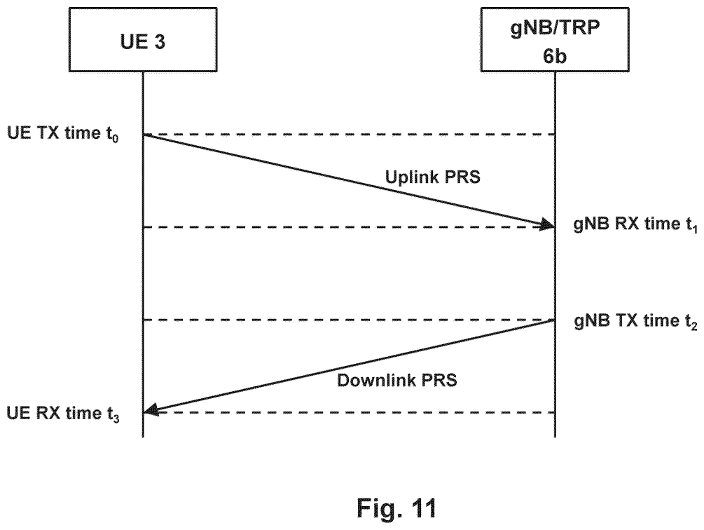

FIG. 11 shows part of a Multi-RTT method for determining a distance between a UE and a gNB/TRP. As shown in the figure, in this example the method comprises the transmission, by the UE3, of an uplink reference signal at a time t₀. The uplink reference signal is received at the gNB/TRP 6b at a time t₁. A downlink reference signal is transmitted by the gNB/TRP 6b at a time t₂, and is received at the UE at a time t₃.

The round-trip time (RTT) is then calculated using the following equation:

RTT=(t₃−t₀)−(t₂−t₁).

The RTT corresponds to the total signal travel distance (twice the distance between the UE 3 and the gNB/TRP 6b) divided by the signal propagation speed (the speed of light). Therefore, since the RTT can be measured as shown in FIG. 11, and the signal propagation speed is known, the distance between the UE 3 and the gNB/TRPs 6b can be calculated. The principle illustrated in FIG. 9 can then be used to estimate the location of the UE 3.

Advantageously, the time measurements of the Multi-RTT method only involve the respective local clocks at the UE and gNB/TRP 6b sides, and no time synchronisation between the nodes is needed.

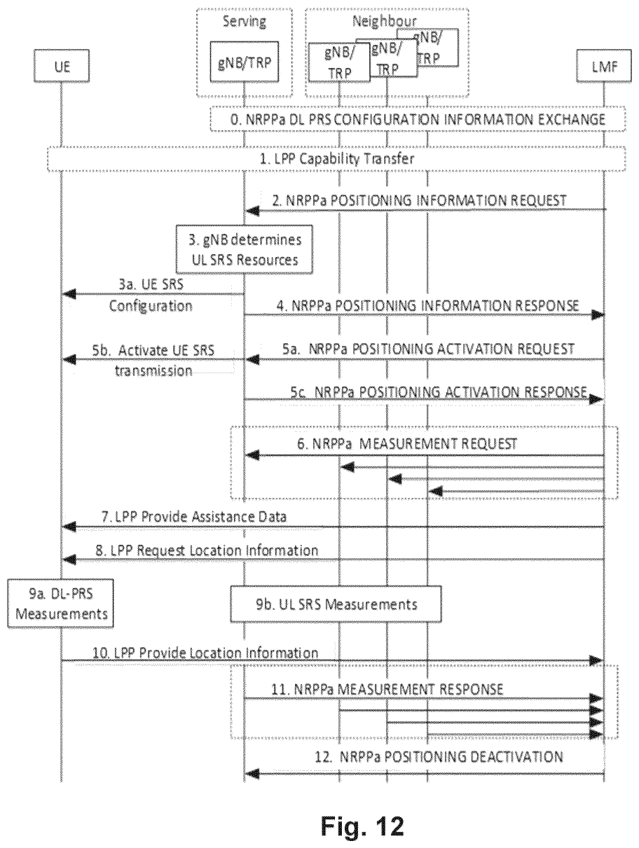

A Multi-RTT procedure is shown in FIG. 12, and is described in detail in TS 38.305.

In the NTN systems illustrated in FIGS. 1 to 4, the signals transmitted between the gNB/TRP 6b and the UE 3 may comprise signals transmitted between satellites 5 of the NTN and the UE3. For example, the RTT could be measured between the satellite 5 and the UE 3 (in which case the RTT corresponds to the RTT of the service link), or could be measured between a terrestrial gNB/TRP 6b and the UE 3 via the satellite 5 (in which case the RTT corresponds to the RTT of the service link and the feeder link).

### UL-AoA (Angle of Arrival)

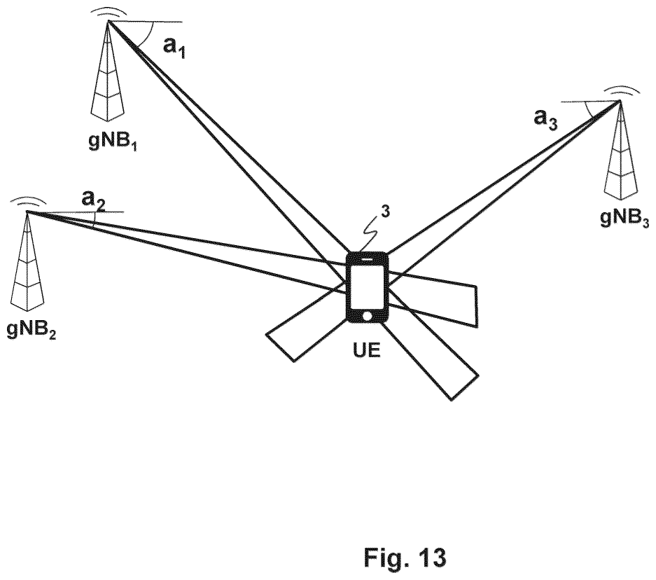

FIG. 13 shows a schematic illustration of uplink angle-of-arrival positioning. In this method, the signals transmitted from the UE 3 to a set of gNBs (gNB₁ to gNB₃) to derive a set of respective angles (azimuth and zenith, a₁ to a₃) between the gNBs 6b and the UE 3. The gNBs 6b measure the angles to the UE 3 using directional antennas.

The UE 3 is triggered by the network to transmit the uplink signal (e.g. a sounding reference signal) for the measurement by the gNBs 3b. The procedure may be transparent to the UE 3.

The gNB/TRPs 6b are instructed to measure the UL-AoA using the uplink signal transmitted by the UE 3. The position of the UE3 can then be estimated in a manner similar to that shown in FIG. 9.

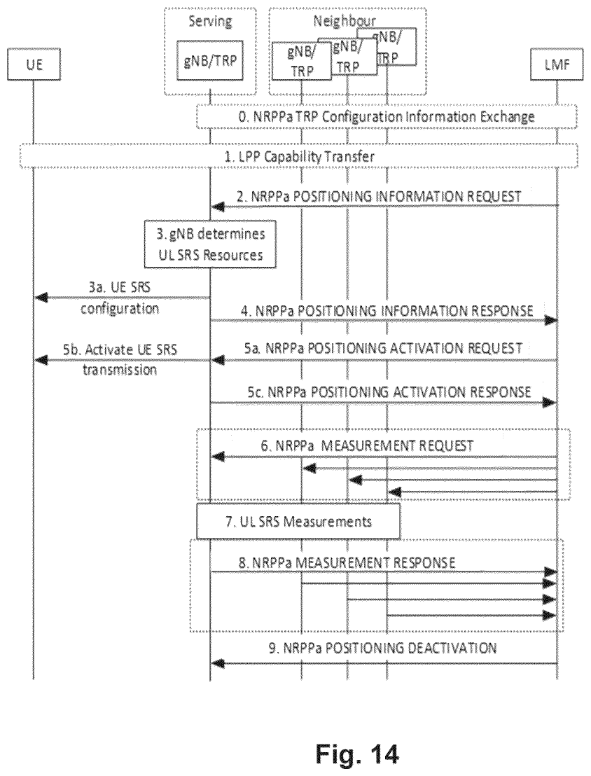

Advantageously, in this method, not common time reference is needed at the TRPs, and so the method is suitable for use in non-synchronised networks. An UL-AoA positioning procedure (also suitable for an UL-TDOA, described below) is shown in FIG. 14, and is described in detail in TS 38.305.

In the NTN systems illustrated in FIGS. 1 to 4, the UL-AoA may be implemented by receiving the reference signal transmitted by the UE 3 at a plurality of non-terrestrial network nodes (e.g. satellites).

### DL-AoD (Angle of Departure)

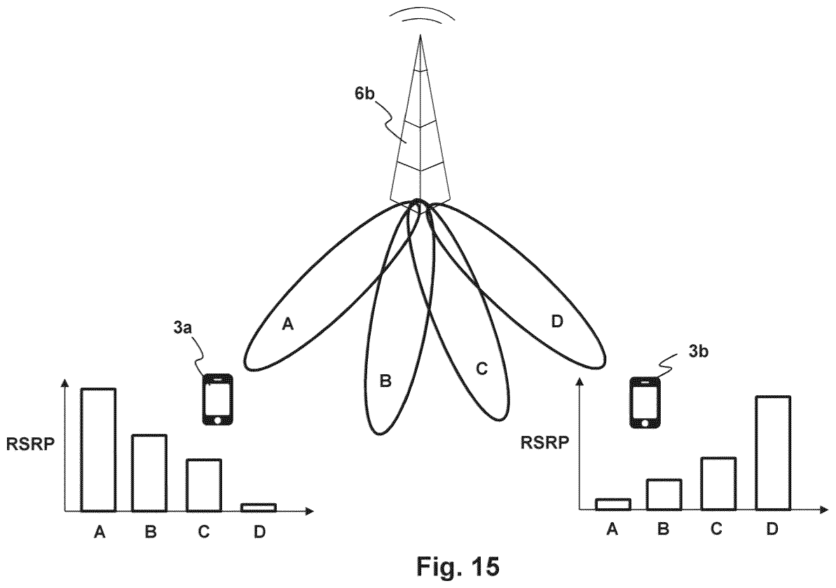

FIG. 15 shows a schematic illustration of downlink angle-of-departure positioning. As shown in the figure, a gNB/TRP 6b transmits a beam-formed reference signal (e.g. DL-PRS) in a beam sweeping manner. In FIG. 15 the beam-formed reference signal is shown in four different directions, A to D, and the respective reference signal received power (RSRP) measurement pattern received at two UEs 3a, 3b is shown. The strength of each of the signals A to D at the UE 3 are used to estimate the position of the UE 3.

The UE 3 is configured to measure the per-beam RSRP of the DL-PRS, and may report the measurement results to the LMF 8. UE-based and network-based positioning modes are available for DL-AoD. In the UE-based mode, the UE 3 may receive assistance data for performing the measurement. For example, the UE 3 may receive information identifying candidate TRPs 6b for the measurement, or information identifying the DL-PRS signal to be measured. The assistance data may be provided using an LTE positioning protocol (LPP) message or positioning system information (Pos SI).

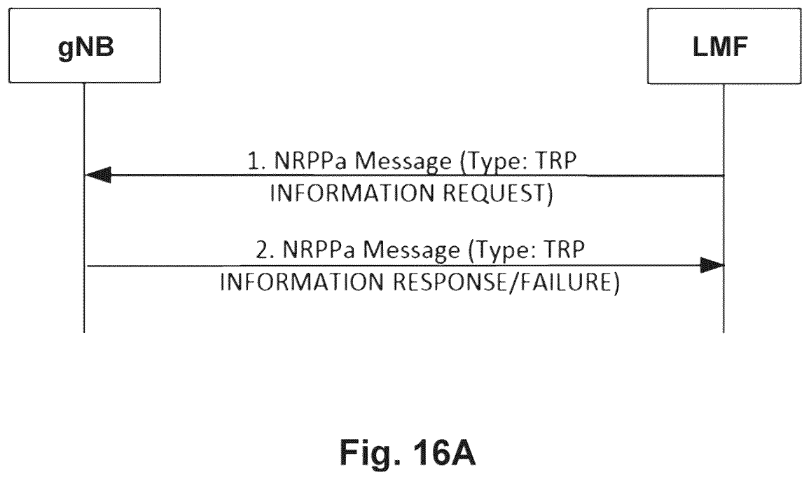

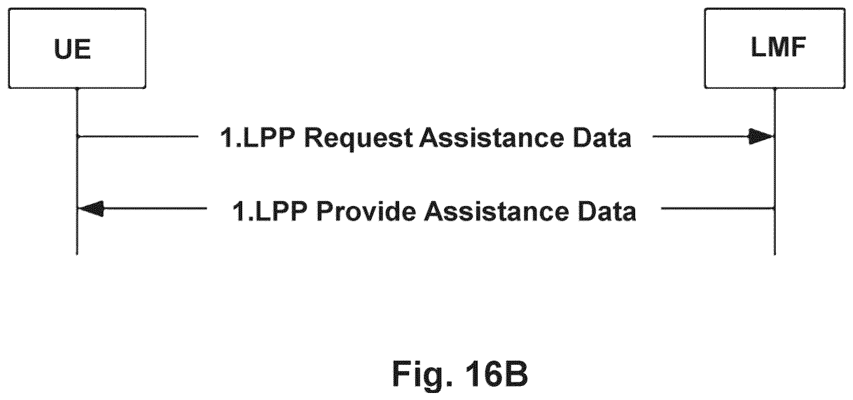

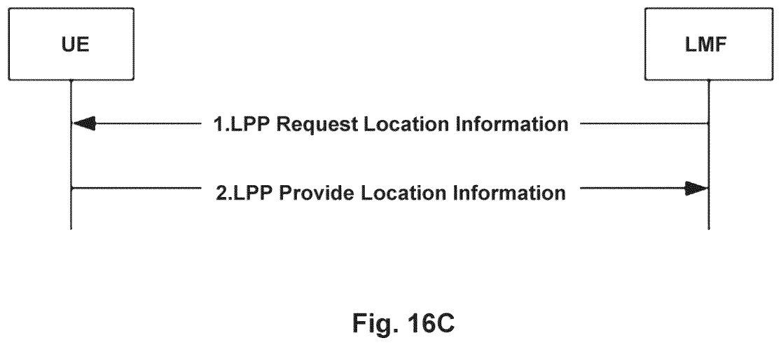

FIGS. 16A to 16C show messages exchanged in the DL-AoD method, and are described in detail in TS 38.305.

### DL-TDOA (Time Difference of Arrival)

The DL-TDOA method is based on Time of Arrival (TOA) measurements of DL PRS signals received from multiple TRPs 6b at the UE 3. The method may also be referred to as “observed time difference of arrival (OTDOA)”. Calculated time differences on arrival (TDOAs) are referred to as DL reference signal time difference (DL-RSTD) measurements.

Three basic quantities associated with DL-TDOA are the OTDOA, the real-time difference (RTD) and the geometric time difference (GTD). The OTDOA is the time interval observed by the UE 3 between the reception of DL PRS from two TRPs 6b. The RTD is the relative synchronisation difference between two TRPs 6b (if the TRPs 6b transmit at exactly the same time, then TRD=0). The GTD is the time difference between the reception of DL from different TRPs 6b due to geometry. The relationship between the OTDOA, TRD and GTD is given by the following equation:

OTDOA=TRD+GTD

In a UE-assisted mode 3, the measurements are provided to the LMF 8. In a UE-based mode, the UE 3 receives location assistance data that includes the geographical locations of candidate TRPs 6b for the measurements. DL-TDOA is described in detail in TS 38.305.

### UL Time Difference of Arrival (TDOA)

TDOA is an uplink positioning method that can be transparent to the UE. An uplink positioning signal is transmitted by the UE 3 and is received at multiple TRPs 6b. The uplink signal is based on a Sounding Reference Signal (SRS). The TRPs 6b know the characteristics of the SRS transmitted by the UE 3, and the characteristics are static over the transmission during the uplink measurements.

The uplink relative time of arrival (UL RTOA) is measured at the TRPs 6b relative to a common timescale. The common timescale may be GPS time, or any other suitable base time that can be shared among the TRPs 6b. The UL reception points for UL-TDOA must be synchronised.

RTOA measurements from the participating TRPs 6b are sent to the LMF 8, together with a time stamp of the measurement. An UL-TDOA positioning procedure is shown in FIG. 14 (which is the same as for UL-AoA) and described in detail in TS 38.305.

### Position Estimation Methods Using Non-Terrestrial Nodes

Improved position estimation methods that use one or more non-terrestrial nodes will now be described. Whilst the methods are described with reference to ‘satellites’, any other suitable type of non-terrestrial node could instead be used. For example, a High-Altitude Platform (HAP), unmanned aerial vehicle (UAV) or drone could be used.

In NTN scenarios, measurements performed by satellites 5 can be used to estimate the position of a UE 3. However, unlike stationary terrestrial nodes, the satellite moves relative to the UE 3 as it progresses along its orbital path. In order to obtain an accurate estimate of the position of the UE 3 it is important to obtain the position of the satellite 5 at the time the measurement took place.

The position of a satellite at the time of a measurement can be determined using a suitable equation or lookup table that specifies the position of the satellite 5 as a function of time. However, compared to terrestrial networks, the propagation delay between the UE 3 and the satellite 5 (the propagation delay of the service link) and the propagation delay between the satellite and the gateway/gNB 6 (the propagation delay of the feeder link) is large. As a result, there can be a significant difference in a time recorded at the satellite that identifies when a measurement has been performed, and a time recorded at a terrestrial node (e.g. the gNB 6b) when the measurement has been received at the terrestrial node. Therefore, it is important to consider which time is used to calculate the position of the satellite when the measurement was performed, in order to obtain an accurate estimate of the position of the UE 3 using the measurement.

The measurement time is an important parameter for the UL-TDOA method for calculating the position of the UE, since a common time scale is used for the positioning method. In other positioning methods, including multi-RTT and UL-AOA, the measurement time is used to improve the accuracy of the estimated of the location of the UE 3. The UE Rx-Tx time difference and the gNB Rx-Tx time difference in multi-RTT can be associated with the measurement time information, so that the LMF 8 can use measurement results at adjacent times to estimate the location of the UE 3.

Improved methods of determining an estimate of a location of a UE using one or more satellites 5 of a terrestrial network are set out below. Advantageously, the positions of the satellites 5 can be reliably and accurately determined, and combined with corresponding measurements from the satellites to estimate a location of a UE 3.

In each of the examples, a satellite 5 of the NTN performs a measurement of a signal transmitted to or from a UE 3 (e.g. as part of any of the above-described UE 3 position estimation methods). The LMF 8 determines an estimate of the position of the UE 4 based on the measurement performed by the satellite 5 and a corresponding position of the satellite 5.

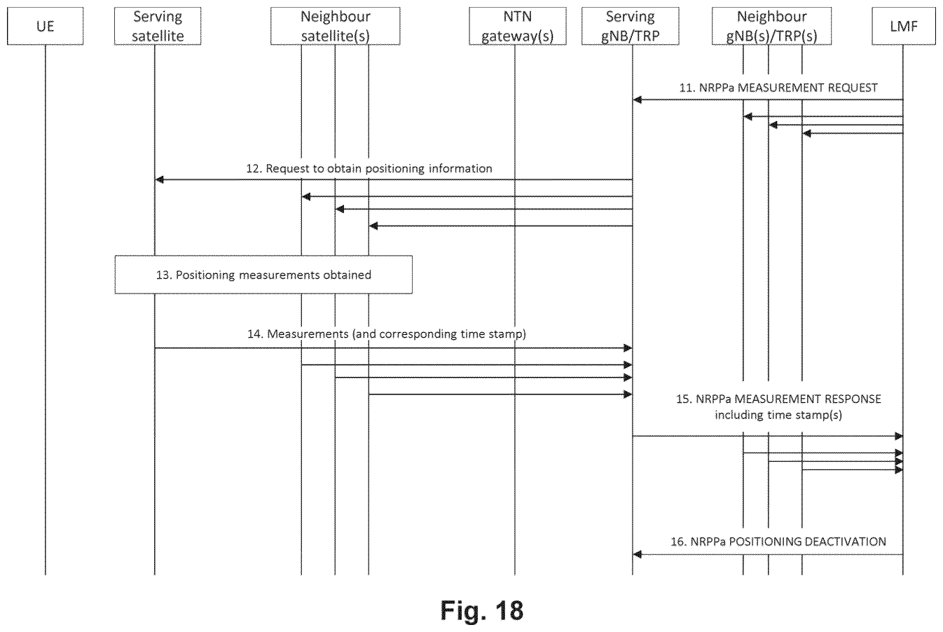

In each of the examples, when time information corresponding to a time at which a measurement by the satellite 5 was performed is transmitted to the LMF 8, the time information may be included (for example) in an NRPPa MEASUREMENT RESPONSE message, or in an NRPPa MEASUREMENT REPORT message (for example, in Step 15 of FIG. 18, described below).

UE Position Estimate Example 1—Time is Associated with the Satellite

In this example, a satellite 5 of the NTN performs a measurement of a signal transmitted to or from a UE 3 (for example, a measurement of one of the above-described methods for determining a position of a UE 3) to obtain measurement information. The measurement information is transmitted to the LMF 8 via the gateway/gNB 6. Time information indicating the time at which the measurement was performed is also transmitted to the LMF 8 from the satellite 5. In this example, the measurement time is associated with the satellite 5. In other words, the measurement time is the time obtained by the satellite 5 as the time at which the measurement was performed.

The time information can be transmitted from the satellite 5 to the LMF 8 in any suitable message or series of messages, for example in an Information Element (IE). The time information may be provided in a higher layer IE, in which case the UE 3 may be capable of performing lower layer procedures such as data decoding.

The time information may be obtained at the satellite 5 using any suitable apparatus. For example, the satellite 5 may comprise a repeater (or any other suitable apparatus), such as a 3GPP Rel 18 network-controlled repeater. The repeater may perform measurements and provide the measurement results and the corresponding time stamp to the LMF 8 via the gNB/TRP 6b.

The LMF 8 obtains satellite path information that indicates the location of the satellite 5 as a function of time. For example, the satellite path information may comprise a formula or table for determining the position of the satellite at a particular time. The satellite path information may comprise, for example, a satellite ephemeris data. Ephemeris data contains information indicating the orbital trajectories of satellites. There are different possible representations/formats of the ephemeris data. One possibility is to use orbital parameters, e.g. semi-major axis, eccentricity, inclination, right ascension of the ascending node, argument of periapsis, mean anomaly at a reference point in time, and the epoch. Another possible option is to provide the location of the satellite in coordinates (x, y, z), e.g. Earth-Centered, Earth-Fixed (ECEF) coordinates. For some types of satellites, a velocity vector (vₓ, v_{y}, v_{z}) and a reference point in time may also be used.

The LMF 8 may obtain the satellite path information from any suitable node in the network. For example, the satellite path information may be received from the gNB 6b, an Access and Mobility Management Function (AMF), from an operation and maintenance (OAM) node, or from any other suitable node (e.g. a server). The satellite path information may be transmitted to the LMF 8 by the gNB 8b in a TRP Information Exchange Procedure.

The LMF 8 determines the position of the satellite 5 that performed the measurement using the received time information (associated with the satellite 5) and the satellite path information.

Alternatively, rather than the location of the satellite being determined at the LMF 8, the LMF 8 may receive the location of the satellite 5 from another suitable node of the network. For example, the location of the satellite 5 at the time the measurement was performed may be determined at the gateway/gNB 6 using the satellite path information (which could be, for example, obtained at the gateway/gNB 6 from any suitable node) and the time information associated with the satellite 5, and the gateway/gNB 6 could transmit the determined location to the LMF 8 for use by the LMF 8 to estimate the position of the UE 3. The location of the satellite 5 may be transmitted from the gateway/gNB 6 to the LMF 8 together with the measurement information from the satellite 5, or separately from the measurement information. In a further alternative, the LMF 8 may receive the location of the satellite from an AMF, or from any other suitable node (e.g. a server).

The LMF 8 uses the determined position of the satellite 5 (either determined at the LMF 8 or received from another network node) and the received measurement information to determine an estimate of the position of the UE 3. The LMF 8 may also use the time the measurement was performed in the determination of the estimate of the position of the UE 3.

The method of example 1 may be used for a satellite 5 with transparent payload onboard, or for a satellite 5 with regenerative payload. When all of the functions of the gNB 6b are provided at the satellite 5 (as illustrated in FIG. 3), the measurement information and time information can be sent to the LMF 8 via the gateway 6a, and the satellite 5 may receive signalling from the LMF 8 directly (via the gateway 6a).

UE Position Estimate Example 2—Time is Associated with the Terrestrial Node

In this example, a satellite 5 of the NTN performs a measurement of a signal transmitted to or from a UE 3. The measurement is then transmitted to the LMF 8 via the gateway/gNB 6. Time information corresponding to measurement is also received at the LMF 8. However, in contrast to Example 1, the time information is associated with the gateway/gNB 6. In other words, the time information that is transmitted to the LMF 8 comprises a time obtained by the gateway/gNB 6 that corresponds to the time at which the measurement was received at the gateway/gNB 6 from the satellite 5.

Due to the signal propagation delay of the feeder link between the satellite 5 and the gateway/gNB 6, the time obtained at the gateway/gNB 6 is corrected so that it can be used to more accurately determine the position of the satellite 5 at the time the measurement was performed. In this example, the gateway/gNB 6 transmits a time offset, in addition to the time obtained by the gateway/gNB 6, to the LMF 8. The time offset corresponds to the time delay between the measurement being performed at the satellite 5 and the measurement being received at the gateway/gNB 6. The LMF 8 can therefore use the time obtained at the gateway/gNB 6 and the time offset to determine the time at which the measurement was performed at the satellite.

Alternatively, the gateway/gNB 6 may send to the LMF 8 the time that the measurement was performed by the satellite. The gateway/gNB 6 may determine the time the measurement was performed at the satellite 5 using the delay (e.g. signal propagation delay) between the satellite 5 and gateway/gNB 6. The LMF 8 can therefore determine the position of the satellite 5 at the measurement time.

As with example 1, the LMF 8 may receive satellite path information from any suitable node in the network. The satellite path information may be received, for example from the gNB 6b, an Access and Mobility Management Function, or from an operation and maintenance, OAM, node. The satellite path information indicates the location of the satellite 5 as a function of time. For example, the satellite path information may comprise a formula or table for determining the position of the satellite at a particular time. The LMF 8 determines the position of the satellite 5 that performed the measurement using the determined time at which the measurement was performed at the satellite, and using the satellite path information.

Alternatively, as with example 1, rather than the location of the satellite being determined at the LMF 8, the LMF 8 may receive the location of the satellite 5 from another suitable node of the network. For example, the location of the satellite 5 at the time the measurement was performed may be determined at the gateway/gNB 6 using the satellite path information (which could be, for example, obtained at the gateway/gNB 6 from any suitable node) and the time information associated with the gateway/gNB 6, and the gateway/gNB 6 could transmit the determined location to the LMF 8 for use by the LMF 8 to estimate the position of the UE 3. The location of the satellite 5 may be transmitted from the gateway/gNB 6 to the LMF 8 together with the measurement information from the satellite 5, or separately from the measurement information. In a further alternative, the LMF 8 may receive the location of the satellite from an AMF, or from any other suitable node (e.g. a server). The LMF 8 may also obtain (e.g. calculate or receive) any other parameters for estimating the position of the UE 3, or for improving the estimate of the position (e.g. the measurement time at the satellite 5, even when the LMF 8 receives the location of the satellite 5 from another entity in the network).

The LMF 8 uses the determined position of the satellite 5 (either determined at the LMF 8 or received from another network node) and the received measurement information to determine an estimate of the position of the UE 3.

The method of example 2 can be used when the satellite 5 is configured to implement a transparent payload, or when the satellite is configured to implement a regenerative payload. Irrespective of whether some of all of the functions of the gNB 6b are provided at the satellite 5, the time offset that is transmitted to the LMF 8 is configured so that the LMF 8 can determine the actual time at which the measurement was performed by the satellite. When the measurement time is generated by a gNB 6b that forms part of the satellite, the time offset need not necessarily be provided, since there is a very small (or negligible) difference between the measurement time generated by the measurement apparatus of the satellite 5 and the corresponding measurement time generated by the gNB 6b provided at the satellite 5. However, the time offset may nevertheless be provided, in order to account for processing time at the gNB 6b or at the measurement apparatus of the satellite 5.

In the example shown in FIG. 2, the time offset may include the signal propagation delay in the feeder link between the satellite 5 and the NTN gateway 6a in addition to an additional signal propagation delay between the NTN gateway 6a and the gNB/TRP 6b. However, if the NTN gateway 6a and the gNB/TRP 6b are co-located (e.g. as shown in FIG. 1), then the additional signal propagation delay between the NTN gateway 6a and the gNB/TRP 6b may be very small (or negligible).

More generally, the value of the time offset can be set to account for any suitable combination of signal propagation delays or processing time delays between the measurement apparatus of the satellite 5 and the gNB/TRP 6b. Advantageously, therefore, the LMF 8 can determine the time at which the measurement was performed at the satellite 5 based on the measurement time information generated by the gNB/TRP 6b and the time offset, enabling the LMF 8 to determine a more accurate position for the satellite 5 that performed the measurement. The LMF 8 may calculate the time of the measurement at the satellite using the following equation:

$${T}_{s} = {T}_{gNB} - {T}_{o} ,$$

where Ts is the time of the measurement at the satellite, T_{gNB} is the time generated by the gNB, and Tₒ is the time offset.

The time offset need not necessarily by transmitted to the LMF 8 from the gNB/TRP 6b. Alternatively, the LMF 8 could receive the time offset from any other suitable network node. Moreover, rather than transmitting the time associated with the gNB/TRP 6b (T_{gNB}) and the time offset (Tₒ) to the LMF 8, the gNB/TRP 6b could calculate the time of the measurement at the satellite using the equation Tₛ=T_{gNB}−Tₒ, and transmit the calculated time to the LMF 8.

In another example, the measurement time information generated by the satellite 5 in the first example and the measurement time information generated at the gNB/TRP 6b in the second example may both be transmitted to the LMF 8 (either together, or separately). The LMF 8 could then determine the location of the satellite 5 using any of the methods of example 1 or of example 2.

### Selection of Non-Terrestrial Nodes

In this example the LMF 8 uses the satellite path information to determine the respective position of one or more satellites 5 of the NTN, and then used the determined position(s) to select one or more of the satellites 5 to perform a measurement for estimating the position of a UE 3.

As described in example 1 and example 2, LMF 8 may receive the satellite path information from any suitable node. The satellite path information may be received, for example from the gNB 6b, an Access and Mobility Management Function, or from an operation and maintenance, OAM, node.

The LMF 8 uses the satellite path information to determine respective positions of one or more satellites 5 of the NTN. The LMF 8 then selects one or more of the satellites 5 to perform a measurement for estimating a location of a UE, based on the determined positions of the satellites 5. The LMF 8 then determines the estimate of the position of a UE using the measurements from the satellites 5 (which are transmitted to the LMF 8 from the satellites 5).

Advantageously, therefore, the LMF 8 is able to determine the respectively locations of satellites 5 in the NTN, and select an appropriate set of the satellites (or single satellite) to perform the positioning procedures.

Alternatively, another node (e.g. the gNB/TRP 6b) could determine the respective satellite 5 positions using the satellite path information, and transmit the determined satellite positions to the LMF 8. The LMF 8 could then select an appropriate set of the satellites (or single satellite) to perform the positioning procedures based on the satellite positions received from the other node.

### Further Examples

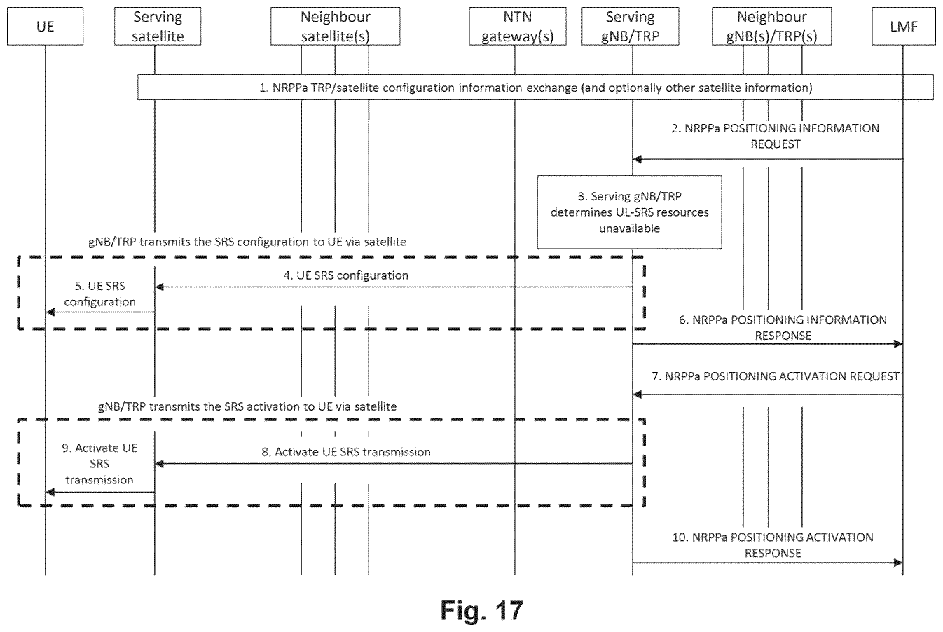

FIGS. 17 and 18 show a UE position estimation method that uses measurements performed by one or more satellites 5 of a non-terrestrial network. FIG. 17 shows the first part of the method, and FIG. 18 shows the second part of the method.

In FIGS. 17 and 18 the method is described with reference to the configuration illustrated in FIG. 4. When the method is applied to the example illustrated in FIG. 3 (in which the functions of the gNB 6b are located at the satellite) the satellites may receive signalling from the LMF 8 directly from the core network (via the NTN gateway 6a). When a part of the gNB 6b is located at the satellite 5, or for satellites with transparent payload onboard, the satellites 5 may receive signalling from the LMF 8 via the gNB 6b and/or via the gateway 6a.

In step 1, satellite configuration information is exchanged (and optionally, additional satellite information is also exchanged). In this example, the information is exchanged using the NR Positioning Protocol A (NRPPa) procedure, although this need not necessarily be the case.

Step 1 may comprise satellite path information being received at the LMF from any suitable network node. Advantageously, the LMF 8 is able to use the satellite path information to determine a location of one or more satellites 5 of the NTN. The LMF 8 can use the determined satellite locations to determine a position estimate of a UE 3 using a set of corresponding measurements performed at the satellites 5, and/or could use the determined satellite locations to select one or more satellites 5 to perform a measurement of a signal transmitted from a UE 3.

In step 2, an NRPPa Positioning Information Request is sent from the LMF 8 to the serving gNB/TRP 6b.

In step 3, the serving gNB/TRP 6b determines that UL-SRS resources are unavailable.

In step 4, the serving gNB/TRP 6b transmits a UE SRS configuration to the serving satellite 5.

In step 5, the serving satellite 5 transmits the UE SRS configuration to the UE 3. In other words, in steps 4 and 5, the serving gNB/TRP 6b transmits the SRS configuration to the UE 3 via the satellite 5.

In step 6, the serving gNB/TRP 6b transmits an NRPPa Positioning Information Response message to the LMF 8.

In step 7, the LMF 8 transmits an NRPPA Positioning Activation Request to the serving gNB/TRP 6b.

In step 8, a message for activating UE SRS transmission is transmitted from the serving gNB/TRP 6b to the serving satellite 5.

In step 9, a message for activating UE 3 SRS transmission is sent from the serving satellite 5 to the UE 3, in order to activate transmission of the SRS by the UE 3.

In step 10, an NRPPa POSITIONING ACTIVATION RESPONSE is transmitted from the serving gNB/TRP 6b to the LMF 8.

In step 11, NRPPa MEASUREMENT REQUESTs are sent from the LMF 8 to the serving gNB/TRP 6b and the neighbouring gNB/TRPs 6b.

In step 12, the serving gNB/TRP 6b and the neighbouring gNB/TRPs 6b transmit respective requests to obtaining positioning information to corresponding satellites of the NTN (the serving satellite 5 and neighbouring satellites).

In step 13 the serving satellite 5 and neighbour satellites 5 perform measurements for determining an estimate of a position of the UE 3. For example, the measurement may be a measurement of the SRS transmitted by the UE 3.

In step 14, measurement information corresponding to the measurements performed by the satellites 5 is sent to the serving gNB/TRP 6b. The information may include the measurement time obtained at each of the satellites for the respective measurements (i.e. the times associated with the satellites).

In step 15, NRPPa MEASUREMENT RESPONSE messages are transmitted from the gNB/TRPs 6b to the LMF 8. The NRPPa MEASUREMENT RESPONSE message from the serving gNB/TRP 6b includes the measurement information receives from the satellites 5, and corresponding time information that indicates the respective times at which the measurements were performed. As described in detail above, the time information received at the LMF 8 may include the time generated at the satellite (associated with the satellite) or the time generated at the gNB/TRP 6b (associated with the gNB/TRP 6b). As described above, when the time received by the LMF 8 in step 15 is the time associated with the gNB/TRP 6b, the gNB/TRP 6b may also transmitted a time offset to the LMF 8, so that the LMF 8 can determine the time at which the measurement was performed at the satellite 5. Whilst in the example shown in FIG. 18 the time information and the measurement information are both sent together in the NRPPa MEASUREMENT RESPONSE, this need not necessarily be the case. Alternatively, the time information and the measurement information may be transmitted to the LMF 8 separately, in any other suitable message or messages.

In step 16, an NRPPA POSITIONING DEACTIVATION message is sent from the LMF 8 to the serving gNB/TRP 6b.

### Modifications and Alternatives

Detailed embodiments have been described above. As those skilled in the art will appreciate, a number of modifications and alternatives can be made to the above example embodiments whilst still benefiting from the inventions embodied therein. By way of illustration only a number of these alternatives and modifications will now be described.

Whilst in the above examples the estimation of the position of the UE has been described as being performed at the LMF 8, this need not necessarily be the case. The procedures performed at the LMF 8 could instead be performed at any other suitable apparatus for estimating a location of a UE (e.g. in different type of network—the above example embodiments may be applied to both 5G New Radio and LTE systems (E-UTRAN)).

It will be appreciated that the above-described examples may be applied to any suitable NTN comprising any suitable type of non-terrestrial node. Example of satellites (GEO, MEO, LEO, etc.) that could be used to perform a measurement for estimating a position of a UE 3 include:

TABLE 1
types of satellites and UAS platforms

| | | | | Typical beam | |
|---|---|---|---|---|---|
| Platforms | Altitude range | | Orbit | footprint size | |
| Low- | 300-1500 | km | Circular around | 100-1000 | km |
| Earth Orbit | | | the earth | | |
| (LEO) satellite | | | | | |
| Medium- | 7000-25000 | km | | 100-1000 | km |
| Earth Orbit | | | | | |
| (MEO) satellite | | | | | |
| Geostationary | 35 786 | km | Notional station | 200-3500 | km |
| Earth Orbit | | | keeping position | | |
| (GEO) satellite | | | fixed in terms | | |
| UAS platform | 8-50 km | | of elevation/ | 5-200 | km |
| (including HAPS) | (20 km for | | azimuth with | | |
| | HAPS) | | respect to a | | |
| | | | given earth | | |
| | | | point | | |
| High | 400-50000 | km | Elliptical around | 200-3500 | km |
| Elliptical Orbit | | | the earth | | |
| (HEO) satellite | | | | | |

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and TS 37.340 V16.7.0 define the following nodes, amongst others:

gNB: node providing NR user plane and control plane protocol terminations towards the UE, and connected via the NG interface to the 5G core network (5GC).

ng-eNB: node providing E-UTRA user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).
NG-RAN node: either a gNB or an ng-eNB.

It will be appreciated that the above example embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

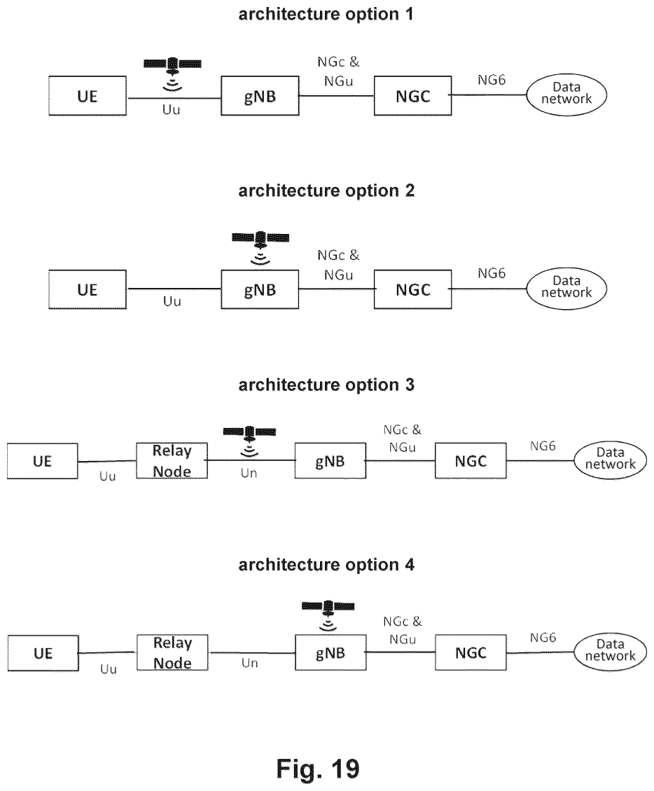

It will be appreciated that there are various architecture options to implement NTN in a 5G system, some of which are illustrated schematically in FIG. 19. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above-described options. Alternatively, the relay node may comprise a satellite/UAS. It will be appreciated that similar architecture options may be used in 4G/LTE systems as well, but with an eNB instead of the gNB, an EPC instead of NGC, and using the appropriate LTE interfaces instead of the NG interfaces shown in FIG. 19.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above example embodiments are also applicable to ‘non-mobile’ or generally stationary user equipment. The above-described mobile device (UE) may comprise an MTC/IoT device, a power saving UE, and/or the like. Various other modifications will be apparent to those skilled in the art and will not be described in further detail here.

The whole or part of the exemplary embodiments disclosed above can be described as, but not limited to, the following supplementary notes.

### Supplementary Note 1

A method performed by a first network node in a network comprising a non-terrestrial network portion, the method comprising:
receiving measurement information corresponding to a measurement performed at a satellite of the non-terrestrial network portion;
obtaining time information that indicates a time at which the measurement was performed at the satellite;
obtaining path information for determining a position of the satellite based on the time information;
determining, using the time information and the path information, a position of the satellite when the measurement was performed at the satellite; and
determining a location of a user equipment, UE, based on the position of the satellite and the measurement information.

### Supplementary Note 2

The method according to Supplementary note 1, wherein the time information comprises at least one of a time associated with the satellite, and a time associated with a second network node that communicates with the satellite.

### Supplementary Note 3

The method according to Supplementary note 2, wherein the method includes receiving at least one of the time information and the measurement information from the second network node.

### Supplementary Note 4

The method according to Supplementary note 3, wherein:
the time information includes the time associated with the second network node; and
wherein the time information includes a time offset between the time associated with the second network node and a time at which the measurement was performed at the satellite.

### Supplementary Note 5

The method according to Supplementary note 4, wherein the time offset includes at least one of a propagation delay of signals between the satellite and the second network node, and a processing time at the second network node.

### Supplementary Note 6

The method according to Supplementary note 4 or 5, further comprising:
calculating, using the time associated with the second network node and the time offset, the time at which the measurement was performed at the satellite; and
determining the position of the satellite using the determined time at which the measurement was performed at the satellite and the path information.

### Supplementary Note 7

The method according to any of Supplementary notes 1 to 6, wherein the path information includes an ephemeris of the satellite.

### Supplementary Note 8

The method according to any of Supplementary notes 1 to 7, wherein the first network node is a Location Management Function, LMF, and the second network node is a base station or a transmission and reception point, TRP.

### Supplementary Note 9

The method according to any of Supplementary notes 1 to 8, wherein the measurement performed at the satellite is based on a reference signal transmitted by the UE.

### Supplementary Note 10

The method according to any of Supplementary notes 1 to 9, further comprising receiving the path information, via a base station, from a function responsible for access and mobility management, or from an operation and maintenance, OAM, node.

### Supplementary Note 11

The method according to Supplementary note 10, wherein the method comprises receiving the path information from the base station in a Transmission/Reception Point, TRP, Information Exchange Procedure.

### Supplementary Note 12

A method performed by a first network node in a network comprising a non-terrestrial network portion, the method comprising:
receiving, from another network node, location information identifying a position of a satellite at which a measurement based on a reference signal from a user equipment, UE, has been performed; and
receiving measurement information corresponding to the measurement performed at the satellite;
wherein the location information indicates the position of the satellite when the measurement was performed; and
wherein the method further comprises determining a position of the UE based on the position of the satellite and based on the measurement information.

### Supplementary Note 13

The method according to Supplementary note 12, wherein the method comprises receiving the location information from a second network node that communicates with the satellite.

### Supplementary Note 14

A method performed by a second network node in a network comprising a non-terrestrial network portion, the method comprising:
obtaining, for a measurement based on a reference signal from a user equipment, UE, at a satellite, time information identifying a time corresponding to when the measurement was performed at the satellite; and
transmitting the time information to a first network node;
wherein the time information comprises at least one of a time associated with the satellite, and a time associated with the second network node.

### Supplementary Note 15

The method according to Supplementary note 14, wherein:
the time identified by the time information is associated with the second network node; and
wherein the method further comprises transmitting, to the first network node, a time offset between the time associated with the second network node and a time at which the measurement was performed at the satellite.

### Supplementary Note 16

The method according to Supplementary note 15, wherein the time offset comprises at least one of a propagation delay of signals between the satellite and the second network node, and a processing time at the second network node.

### Supplementary Note 17

The method according to any of Supplementary notes 14 to 16, wherein the first network node is a Location Management Function, LMF, and the second network node is a base station or a transmission and reception point, TRP.

### Supplementary Note 18

The method according to any one of Supplementary notes 14 to 17, wherein the method further comprises transmitting, to the UE via the satellite, a reference signal configuration for transmitting the reference signal.

### Supplementary Note 19

The method according to Supplementary note 18, wherein the method further comprises transmitting, to the UE via the satellite, an instruction to activate transmission of the reference signal.

### Supplementary Note 20

A method performed by a first network node in a network comprising a non-terrestrial network portion, the method comprising:
obtaining path information for determining a position of one or more satellites of the non-terrestrial network portion;
determining, using the path information, respective positions of one or more satellites of the non-terrestrial network portion; and
selecting, using the respective positions, one or more satellites to perform a measurement of a signal transmitted by a user equipment, UE, for determining a position of the UE.

### Supplementary Note 21

The method according to Supplementary note 20, wherein the method comprises receiving the path information from:
a second network node that communicates with one or more satellites of the non-terrestrial network portion;
a function responsible for access and mobility management; or
an operation and maintenance, OAM, node.

### Supplementary Note 22

A method performed by a second network node in a network comprising a non-terrestrial network portion, the method comprising:
receiving measurement information corresponding to a measurement performed at a satellite of the non-terrestrial network portion;
obtaining time information that indicates a time at which the measurement was performed at the satellite;
obtaining path information for determining a position of the satellite based on the obtained time information;
determining, using the time information and the path information, a position of the satellite when the measurement was performed at the satellite; and
transmitting the measurement information and location information that identifies the position of the satellite to a first network node for determining a location of a user equipment, UE.

### Supplementary Note 23

The method according to Supplementary note 22, wherein the method further comprises transmitting the time information to the first network node for determining a location of the UE.

### Supplementary Note 24

A first network node in a network comprising a non-terrestrial network portion, the first network node comprising:
means for receiving measurement information corresponding to a measurement performed at a satellite of the non-terrestrial network portion;
means for obtaining time information that indicates a time at which the measurement was performed at the satellite;
means for obtaining path information for determining a position of the satellite based on the time information;
means for determining, using the time information and the path information, a position of the satellite when the measurement was performed at the satellite; and
means for determining a location of a user equipment, UE, based on the position of the satellite and the measurement information.

### Supplementary Note 25

A first network node in a network comprising a non-terrestrial network portion, the first network node comprising:
means for receiving, from another network node, location information identifying a position of a satellite at which a measurement based on a reference signal from a user equipment, UE, has been performed; and
means for receiving measurement information corresponding to the measurement performed at the satellite;
wherein the location information indicates the position of the satellite when the measurement was performed; and
wherein the method further comprises determining a position of the UE based on the position of the satellite and based on the measurement information.

### Supplementary Note 26

A first network node in a network comprising a non-terrestrial network portion, the first network node comprising:
means for obtaining path information for determining a position of one or more satellites of the non-terrestrial network portion;
means for determining, using the path information, respective positions of one or more satellites of the non-terrestrial network portion; and
means for selecting, using the respective positions, one or more satellites to perform a measurement of a signal transmitted by a user equipment, UE, for determining a position of the UE.

### Supplementary Note 27

A second network node in a network comprising a non-terrestrial network portion, the second network node comprising:
means for obtaining, for a measurement based on a reference signal from a user equipment, UE, at a satellite, time information identifying a time corresponding to when the measurement was performed at the satellite; and
means for transmitting the time information to a first network node;
wherein the time information comprises at least one of a time associated with the satellite, and a time associated with the second network node.

### Supplementary Note 28

A second network node in a network comprising a non-terrestrial network portion, the second network node comprising:
means for receiving measurement information corresponding to a measurement performed at a satellite of the non-terrestrial network portion;
means for obtaining time information that indicates a time at which the measurement was performed at the satellite;
means for obtaining path information for determining a position of the satellite based on the obtained time information;
means for determining, using the time information and the path information, a position of the satellite when the measurement was performed at the satellite; and
means for transmitting the measurement information and location information that identifies the position of the satellite to a first network node for determining a location of a user equipment, UE.

This application is based upon and claims the benefit of priority from United Kingdom patent application No. 2205224.5, filed on Apr. 8, 2022, the disclosure of which is incorporated herein in its entirety by reference.

### REFERENCE SIGNS LIST

1 Mobile (cellular or wireless) telecommunication system
3 Mobile device
5 Satellite
6 Base station
8 Location Management Function
31,51, 71, 91 Transceiver circuit
33, 53, 73 Antenna
35 User interface
37, 55, 77, 93 Controller
39, 57, 79, 94 Memory
41, 59, 81, 95 Operating system
43,61, 96 Communications control module
45 Reference signal module
63,83 Communications control module
75, 92 Network interface
85, 97 Position estimation module

What is claimed is:

1. A method performed by a Location Management Function (LMF) node in a network comprising a non-terrestrial network portion, the method comprising:
receiving, from an access network node, measurement information corresponding to a measurement of a user equipment (UE) via a satellite of the non-terrestrial network portion;
receiving, from an operation and maintenance (OAM) node, assistance information for determining a position of the satellite;
determining, using the assistance information, a position of the satellite; and
determining a location of the UE based on the position of the satellite and the measurement information.

2. The method according to claim 1, wherein
the assistance information indicates an ephemeris of the satellite.

3. (canceled)

4. The method according to claim 2, wherein
the determining includes determining respective positions of a plurality of satellites when the measurement was performed,
the receiving includes respective assistance information corresponding to the plurality of the satellites, and
the method comprises selecting one of the plurality of satellites for use in the determining the location of the UE, based on the respective positions and the respective assistance information.

5. The method according to claim 1, further comprising:
receiving, from a second network node, time information indicating a time at which the measurement was performed, and
wherein the determining the position of the satellite includes determining, using the time information, the position of the satellite when the measurement was performed.

6. The method according to claim 5, wherein
the time information includes:
first information indicating a time at which the measurement was received at the second network node; and
second information indicating a time offset corresponding to the satellite and the second network node, and
the method comprises determining the time at which the measurement was performed, based on the first information and the second information.

7. The method according to claim 6, wherein
the time offset includes at least one of:
a propagation delay of signalling between the satellite and the second network node, and
a processing time at the second network node.

8. The method according to claim 5, wherein
the time information is generated, by the second network node, by calculating the time at which the measurement was performed based on a time at which the measurement was received at the second network node and a propagation delay between the satellite and the second network node.

9. The method according to claim 5, wherein
the time information is included in at least one of a measurement report message and a measurement response message.

10. The method according to claim 1, further comprising:
receiving, from a second network node, location information indicating the position of the satellite when the measurement was performed, and
wherein the position of the satellite when the measurement was performed is calculated by the second network node.

11. The method according to claim 10, further comprising:
requesting the second network node for the location information, and
wherein the receiving is performed in response to the requesting.

12. The method according to claim 1, wherein
the measurement is based on a reference signal transmitted by the satellite.

13. The method according to claim 1, wherein
the second network node includes at least one of:
an access network node,
a transmission and reception point, TRP,
a core network node for mobility management, and
an operation and maintenance, OAM, node.

14. (canceled)

15. A method performed by an operation and maintenance (OAM) node in a network comprising a non-terrestrial network portion, the method comprising:
transmitting, to a Location Management Function (LMF) node, assistance information for determining a position of the satellite, and
wherein measurement information corresponding to a measurement of a user equipment (UE) is transmitted from an access network node to the LMF node via a satellite of the non-terrestrial network portion, and
wherein the measurement information and the assistance information are used by the LMF node in determining a position of the satellite and determining a location of the UE.

16-24. (canceled)

25. A Location Management Function (LMF) node in a network comprising a non-terrestrial network portion, the LMF node comprising:
at least one memory storing instructions; and
at least one processor configured to process the instructions to:
receive, from an access network node, measurement information corresponding to a measurement of a user equipment (UE) via a satellite of the non-terrestrial network portion;
receive, from an operation and maintenance (OAM) node, assistance information for determining a position of the satellite;
determine, using the assistance information, a position of the satellite when the measurement was performed; and
determine a location of the UE based on the position of the satellite and the measurement information.

26. An operation and maintenance (OAM) node in a network comprising a non-terrestrial network portion, the OAM node comprising:
at least one memory storing instructions; and
at least one processor configured to process the instructions to:
transmit, to a Location Management Function (LMF) node, assistance information for determining a position of the satellite, and
wherein measurement information corresponding to a measurement of a user equipment (UE) is transmitted from an access network node to the LMF node via a satellite of the non-terrestrial network portion, and
wherein the measurement information and the assistance information are used by the LMF node in determining a position of the satellite and determining a location of the UE.
